(19) United States
(12) Patent Application Publication
(10) Pub. No.: US 2006/0119322 A1
(43) Pub. Date: Jun. 8, 2006

(54) Battery pack with temperature activated boost

(76) Inventors: Hossein Maleki, Lawrenceville, GA (US); Daniel J. Jakl, Lawrenceville, GA (US); James O. Krause, Norcoss, GA (US)

Correspondence Address: MOTOROLA, INC.;LAW DEPARTMENT, 600 NORTH U.S. HIGHWAY 45, AS437, LIBERTYVILLE, IL, 60048, US

(21) Appl. No.: 11/004,295

(22) Filed: Dec. 4, 2004

(51) Int. Cl. H02J 7/00

(52) U.S. Cl. 320/150

(57) ABSTRACT

A battery pack having at least one electrochemical cell and a temperature dependent boost circuit is provided. Since the cell voltage is diminished at low temperatures, and as portable electronic devices typically have a minimum operational voltage limit, the boost circuit is actuated at low temperatures to step up the voltage from the cell to the electronic device. In one embodiment, the boost circuit is coupled serially between the cell and the output terminals of the battery pack. In parallel with the boost circuit is a boost bypass circuit. A controller senses the temperature of the battery pack from a temperature sensor, like a thermistor. When the temperature falls below a predetermined minimum temperature threshold, the controller actuates the boost circuit, thereby increasing the output voltage of the pack. Concurrently with the actuation of the boost circuit, the controller causes the boost bypass circuit to enter a high impedance state.

### BACKGROUND

1. Technical Field

This invention relates generally battery packs, and more specifically to a battery pack having a temperature dependent boost circuit embedded therein.

2. Background Art

Personal electronic devices are widely used in today's information age. Cellular telephones, two-way radios, pagers, personal data assistants, portable computers and multimedia players are only some of the devices commonly used by people to stay organized and informed. Many individuals carry such devices wherever they go, outdoors as well as indoors. Rechargeable batteries are the workhorses that provide energy to these devices. Rechargeable batteries offer the user freedom of movement without having to sacrifice functionality of such devices.

Lithium ion batteries are the most popular choice in rechargeable applications due to their high energy storage to weight ratio. Lithium-based batteries, however, tend to be temperature sensitive and may experience a shortened life span or reduced energy capacity when exposed to cold temperatures. Nonetheless, many applications demand that portable electronic devices be fully operational in cold environments. For example, policemen on the beat in northern regions need their radios to be operational regardless of the temperature. Additionally, construction workers need power tools to work in cold environments as well.

Prior art solutions for keeping lithium batteries warm include coupling a resistive heater to the battery pack. The resistive heater heats the battery to a warmer temperature, thereby allowing the battery to provide its full energy capability, thus returning some of the effective energy storage capacity. The problem with this solution is that the resistive heater must have an energy source to generate heat. Since some rechargeable cells have little capacity at low temperatures, a user must plug such a heater into an alternate power source, like a wall outlet. This plug requirement eliminates the portability of the device.

There is thus a need for a battery pack that remains operational at low temperatures.

### BRIEF DESCRIPTION OF THE DRAWINGS

FIG. 1 is a schematic diagram of one embodiment of a battery pack in accordance with the invention.

FIG. 2 illustrates a software flow chart suitable for operation in a microcontroller in a battery pack in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention is a battery pack having a temperature dependent boost circuit for increasing the cell voltage at cold temperatures. In other words, the available cell voltage is multiplied by the boost circuit into a range usable by a host device. The battery pack includes at least one electrochemical cell, like a high rate lithium-ion cell for example. A boost circuit, which increases, or “boosts” the voltage of the cell, is coupled in series with the electrochemical cell. A controller, like a microcontroller or application specific pulse width modulator for example, is coupled to the boost circuit. The controller is capable of actuating, disabling and regulating the boost circuit.

In parallel with the boost circuit is a boost bypass circuit. The boost bypass circuit, which may be as simple as a transistor, is capable of either blocking current by entering a high impedance state, or passing current by entering a low-impedance state. The state of the bypass circuit is controlled by the controller.

A temperature sensor, like a thermistor or temperature sensitive resistor for example, is coupled to the controller. The temperature sensor indicates relative temperature to the controller by changing a characteristic like impedance.

When the controller senses that the temperature has fallen below a predetermined minimum temperature threshold, the controller knows that the cell voltage of the electrochemical cell is low due to the operational characteristics of the cell. Note that the predetermined minimum temperature threshold will be determined by, among other things, the discharge efficiency characteristics of the particular cell used with the invention. As such, the controller actuates the boost circuit, thereby making it operational so as to increase the output voltage of the battery pack. As electronic devices typically only work when the voltage of the attached battery is above a minimum threshold, this increased voltage keeps the attached electronic device operational in cold environments. Concurrent with actuating the boost circuit, the controller causes the boost bypass circuit to enter a high impedance state.

By way of background, as noted above, standard Li-ion cells, for example cells with LiCoO₂ cathodes and graphite anodes typically have little or no energy storage capacity at low temperatures. For example, the typical LiCoO₂/graphite cell stores less than 1% of its full capacity at temperatures below −20 degrees centigrade.

However, recent developments in lithium technology have produced cells that do have substantive energy storage capacities at low temperatures. For example, experimental results have shown that cells manufactured by Sony, Inc. can deliver as much as 20% of their full energy storage capacity below −20 degrees centigrade. These types of cells, i.e. those that maintain substantive energy storage capacity at low temperatures, will be referred to herein as “high rate” cells.

There are two methods of creating high rate cells. The first method is to use lithium iron phosphate as the cathode material. This cathode material is then either doped with metallic elements or coated with a highly electrically conductive material, such as carbon. The second method is to use traditional lithium cobalt oxide, manufactured in fine primary particles measuring less than 5 microns in diameter, and to change the physical parameters of the cell so that the cell's internal impedance is minimized. By way of example, one might design the cell with thick current collectors, or apply a thin coating of active materials on the current collector, or design the current collector material to be longer than in standard cells, or use a high concentration of low viscosity solvents (for example, propylene carbonate, ethylmethyl-carbonate, diethyl-carbonate) and high ionic conductivity lithium-based salts for the electrolyte. In any event, high rate cells are commercially available from companies like Sony.

The problem with high rate cells, however, is that the cell voltage is greatly diminished at low temperatures. In other words, the cell can deliver energy, but the output voltage is considerably lower than it is at, for example, room temperature. This causes a problem with electronic devices in that most devices have a low voltage limit below which either they can not operate or they disable functions. Consequently, even though there is energy in the cell, the electronic device still shuts off due to the low cell voltage. The present invention solves this issue by incorporating a temperature dependent boost circuit in the battery pack.

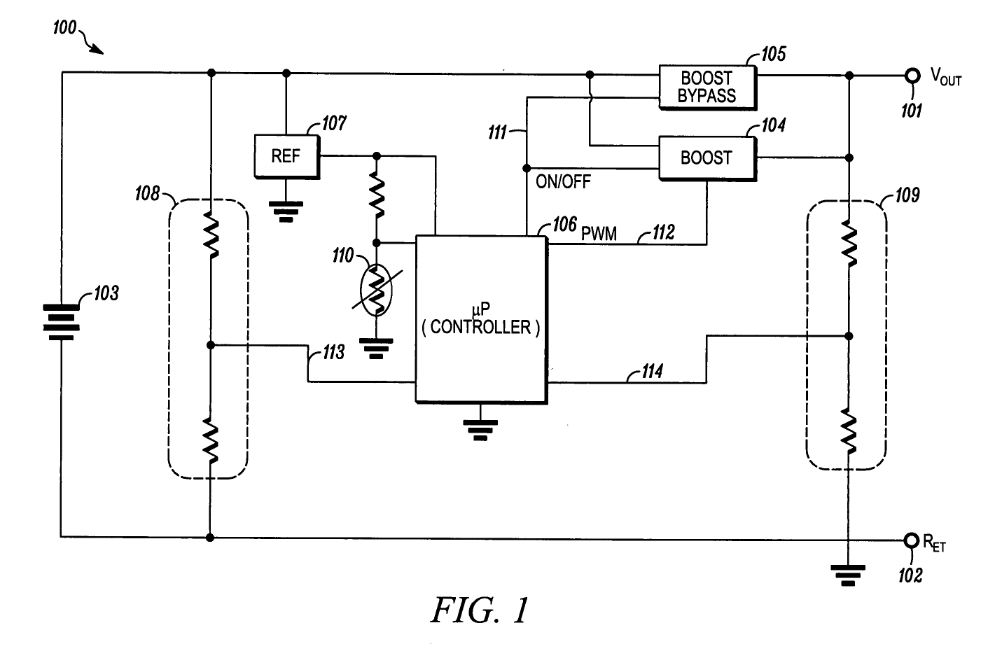

Turning now to FIG. 1, illustrated therein is a schematic diagram of one preferred embodiment of the invention. A battery pack 100 is shown having a positive terminal 101 and a return terminal 102 for coupling to a load, like a portable electronic device. The pack 100 includes at least one cell 103, for example a rechargeable electrochemical cell like a high rate lithium ion cell.

Coupled serially between the positive terminal 101 and the cell 103 is a boost circuit 104. Boost circuits are well known to those of ordinary skill in the art and generally include an inductor, switch, diode and capacitor. The switch periodically couples an input voltage to ground through the inductor, thereby storing energy in the inductor. When the switch is opened, the energy stored in the inductor passes through the diode to the capacitor at a voltage higher than that of the input voltage.

In parallel with the boost circuit 104 is a boost bypass circuit 105. The boost bypass circuit 105 may be as simple as a transistor coupled in parallel with the boost circuit 104. The boost bypass circuit 105 is capable of allowing or stopping the flow of current by switching between a low impedance state and a high impedance state.

Both the boost regulator 104 and the boost bypass circuit are controlled by the controller 106, which may be a microcontroller, a discrete circuit or an application specific circuit that includes a pulse width modulator or equivalent switching signal. The controller 106 can actuate, regulate or disable the boost circuit 104. This is done with an on/off control line 111 and a regulation signal, like a pulse width modulated signal 11 2, where required. Additionally, the controller 106 can cause the boost bypass circuit 105 to enter either a high impedance state or a low impedance state by way of the on/off line 111.

The controller 106 receives several inputs from the circuit. A first input is a reference voltage provided by a voltage reference 107. The voltage reference 107 may be integral to the controller 106, or may be a separate component as is shown in FIG. 1. The voltage reference provides a reference voltage against which the other inputs of the circuit may be compared.

A second input is a scaled cell voltage 113 that is proportional to the cell voltage. In the exemplary embodiment of FIG. 1, the voltage proportional to the cell voltage is generated by a resistor divider 108. A third input is a scaled pack voltage 114. Again, in the exemplary embodiment of FIG. 1, this scaled pack voltage 114 is generated by a second resistor divider 109.

A fourth input is from a temperature sensor 110. The temperature sensor 110 may be a thermistor, positive temperature coefficient device, negative temperature coefficient device, temperature sensitive resistor, thermocouple, or other device. The temperature sensor 110 generates a signal indicative of the temperature of either the cell 103 or the overall pack 100, depending upon where it is positioned within the pack 100.

As the cell voltage falls with temperature, and when the controller 106 sees that the temperature has fallen below the predetermined minimum temperature threshold, like −20 degrees centigrade for example, as indicated by the temperature sensor 110, the controller 106 actuates the boost circuit 104. (Note that other, optional steps may be taken prior to actuation of the boost circuit 104. For example, the controller 106 may additionally check the pack output voltage or cell voltage to ensure that actuation of the boost circuit 104 does not damage either the load or the cell 103.) This actuation causes the voltage of the cell 103 to be “stepped up”, or increased, such that the voltage at the terminals 101,102 is higher than the voltage of the cell 103. This ensures that the portable electronic device coupled to the pack 100 will remain operational, even at low temperatures.

To ensure that all of the energy in the cell 103 passes through the boost circuit 104, upon actuation of the boost circuit 104, the controller 106 causes the boost bypass circuit 105 to enter a high impedance state. This causes current to flow through the boost circuit 104 rather than through the boost bypass circuit 105.

In similar fashion, when the temperature sensor 110 indicates that the temperature is above the predetermined threshold, the controller 106 disables the boost circuit 104. Additionally, when the temperature sensor 110 indicates that the temperature is above the predetermined threshold, the controller 106 causes the bypass circuit 105 to enter a low impedance state. This disabling of the boost circuit 104 and enabling of the boost bypass circuit 105 reduces the overall current drain of the circuitry internal to the battery pack 100 when the pack 100 is operating at normal temperatures. Additionally, the overall pack efficiency is increased by disabling the boost circuit 104 at temperatures above the predetermined minimum threshold. In one embodiment, a preferred range of temperatures in which it is desirable to have the boost circuit 104 operational is 0 to −40 degrees centigrade.

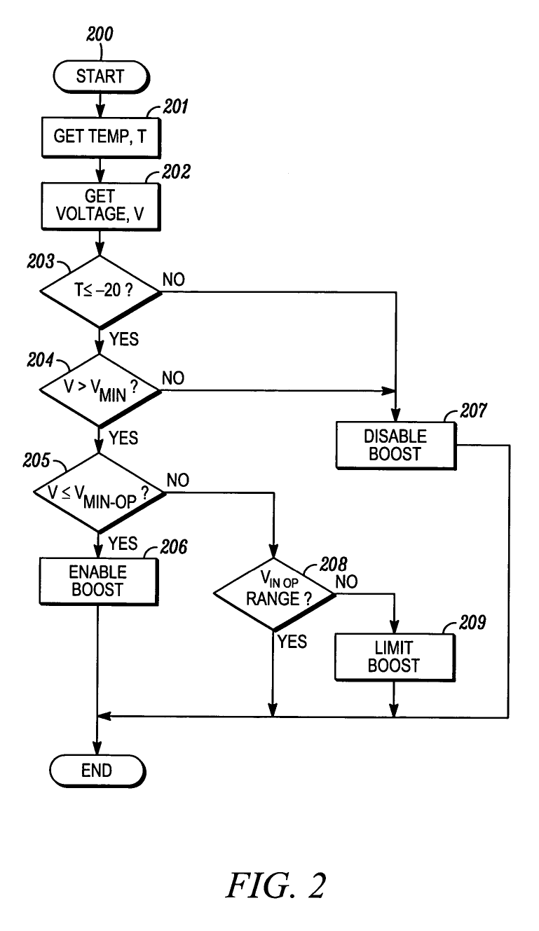

In one preferred embodiment, the controller 106 is a microcontroller running operational software. Turning now to FIG. 2, illustrated therein is a fundamental flow diagram of a set of operating steps that may comprise steps within that operational software. For example, the steps of FIG. 2 may constitute a subroutine in a software program running on the microcontroller. Alternately, the flow chart could be indicative of the operation of an equivalent hardware circuit.

The steps begin at the starting point 200. The software initially instructs the microcontroller to determine the temperature of the battery pack at step 201. The voltage of the cell is then determined at step 202.

At step 203, the microcontroller determines whether the temperature is below the predetermined minimum temperature threshold, like -20 degrees centigrade, for example. If the temperature is above this threshold, the boost circuit is disabled at step 207. This may be due to the fact that the efficiency of the cell discharge by itself is greater than the efficiency of the boost circuit.

At optional step 204, the microcontroller determines whether the cell voltage is above a predetermined minimum operational voltage threshold. This ensures that the battery pack is not operating at a temperature and voltage that is below the recommended operational limits of the cell.

At optional step 205, the microcontroller determines whether the output voltage of the battery pack is less than a minimum operational voltage threshold of the attached electronic device. If the answer is yes, this is indicative of both the cell voltage being above the predetermined minimum operational voltage threshold and the temperature is below the predetermined minimum temperature threshold. In this case, the boost circuit is enabled at step 206. Concurrently, the microcontroller would cause the boost bypass circuit to enter a high impedance state.

Had the voltage been below the predetermined minimum operational threshold at step 204, or had the temperature been above the minimum temperature threshold at step 203, the microcontroller would have disabled the boost circuit at step 207. Concurrently, the microcontroller would cause the boost bypass circuit to enter a low impedance state.

Where both the temperature is below the predetermined minimum threshold and the cell voltage is above the predetermined minimum operating threshold, the microcontroller may check the pack output voltage at step 205 to determine whether the pack output voltage is sufficient to operate the attached electronic device. If the pack voltage is too low, the microcontroller will actuate the boost circuit at step 206.

At step 205, if the pack voltage is sufficient to operate the attached electronic device, the microcontroller moves to step 208. At step 208, the microcontroller may monitor either the cell voltage or the pack voltage to determine whether that voltage remains within the acceptable limits for the desired operational mode of the attached electronic device. If so, and if the boost circuit is actuated, the pack may be able to become more efficient by reducing the amount of boost at step 209.

To summarize, one embodiment of this invention comprises a rechargeable battery pack having at least one rechargeable electrochemical cell, a microcontroller, a reference voltage coupled to the microcontroller, and a boost circuit coupled serially with the at least one rechargeable electrochemical cell. A bypass circuit is coupled in parallel with the boost circuit, and both a reference voltage and a temperature sensor is coupled to the microcontroller.

In one embodiment, when a voltage proportional to a voltage across the at least one rechargeable cell falls below a predetermined minimum, and when the temperature sensor indicates that temperature has fallen below a predetermined minimum temperature threshold, the controller actuates the boost circuit. Concurrently the microcontroller causes the bypass circuit to enter a high impedance state.

When either the voltage proportional to the voltage across the at least one rechargeable cell exceeds the predetermined minimum or when the temperature sensor indicates that the temperature exceeds the predetermined minimum temperature threshold, the microcontroller disables the boost circuit. Concurrently, the microcontroller causes the bypass circuit to enter a low impedance state.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

What is claimed is:

1. A battery pack, comprising:
a. at least one electrochemical cell, the at least one electrochemical cell having a cell voltage;
b. a boost circuit;
c. a controller; and
d. a temperature sensor;
wherein when temperature is below a predetermined minimum temperature threshold, the boost circuit is operational.

2. The pack of claim 1, wherein when the temperature is above the predetermined minimum temperature threshold, the boost circuit is not operational.

3. The pack of claim 1, further comprising a boost bypass circuit coupled in parallel with the boost circuit, wherein when the temperature is below a predetermined minimum temperature threshold, the boost bypass circuit is in a high impedance state.

4. The pack of claim 1, wherein the predetermined minimum temperature threshold is between 0 and −40 degrees centigrade.

5. The pack of claim 1, wherein the controller comprises a microcontroller running operational software.

6. The pack of claim 5, wherein the operational software comprises a plurality of operating steps, the steps comprising:
a. determining the temperature of the battery pack;
b. determining the cell voltage;
c. determining whether the temperature is below the predetermined minimum temperature threshold;
d. determining whether the cell voltage is above a predetermined minimum operational voltage threshold; and
e. actuating the boost circuit when both the cell voltage is below the predetermined minimum operational voltage threshold and the temperature is below the predetermined minimum temperature threshold.

7. The pack of claim 6, wherein the software further comprises the step of causing a bypass circuit coupled in parallel with the boost circuit to enter a high impedance state when both the cell voltage is below the predetermined minimum operational voltage threshold and the temperature is below the predetermined minimum temperature threshold.

8. A rechargeable battery pack, comprising:
a. at least one rechargeable electrochemical cell;
b. a microcontroller;
c. a reference voltage coupled to the microcontroller;
d. a boost circuit coupled serially with the at least one rechargeable electrochemical cell;
e. a bypass circuit coupled in parallel with the boost circuit; and
f. a temperature sensor;
wherein when a voltage proportional to a voltage across the at least one rechargeable cell falls below the reference voltage, and when the temperature sensor indicates that temperature has fallen below a predetermined minimum temperature threshold, the microcontroller actuates the boost circuit.

9. The pack of claim 8, wherein when the voltage proportional to the voltage across the at least one rechargeable cell falls below the reference voltage, and when the temperature sensor indicates that the temperature has fallen below the predetermined minimum temperature threshold, the microcontroller causes the bypass circuit to enter a high impedance state.

10. The pack of claim 8, wherein when either the voltage proportional to the voltage across the at least one rechargeable cell exceeds the reference voltage or when the temperature sensor indicates that the temperature exceeds the predetermined minimum temperature threshold, the microcontroller disables the boost circuit.

11. The pack of claim 10, wherein when either the voltage proportional to the voltage across the at least one rechargeable cell exceeds the reference voltage or when the temperature sensor indicates that the temperature exceeds the predetermined minimum temperature threshold, the microcontroller causes the bypass circuit to enter a low impedance state.

12. A rechargeable battery pack, comprising:
a. a positive terminal and a return terminal;
b. at least one rechargeable, electrochemical cell;
c. a boost circuit coupled serially between the at least one rechargeable, electrochemical cell and the positive terminal;
d. a bypass circuit coupled in parallel with the boost circuit;
e. a controller coupled to both the boost circuit and the bypass circuit; and
f. a temperature sensor coupled to the controller;
wherein when the temperature sensor indicates that temperature has fallen below a predetermined threshold, the controller actuates the boost circuit.

13. The pack of claim 12, wherein when the temperature sensor indicates that temperature has fallen below the predetermined threshold, the controller causes the bypass circuit to enter a high impedance state.

14. The pack of claim 13, wherein when the temperature sensor indicates that the temperature is above the predetermined threshold, the controller disables the boost circuit.

15. The pack of claim 14, wherein when the temperature sensor indicates that the temperature is above the predetermined threshold, the controller causes the bypass circuit to enter a low impedance state.
